(19) United States
(12) Patent Application Publication
(10) Pub. No.: US 2004/0148310 A1
(43) Pub. Date: Jul. 29, 2004

(54) Utility scoring method and apparatus

(76) Inventors: Chirstopher William Preist, Bristol (GB); Claudio Bartolini, Menol Park, CA (US); Andrew Robert Byde, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/473,606

(22) PCT Filed: Apr. 11, 2002
(86) PCT No.: PCT/GB02/01701

(30) Foreign Application Priority Data
Apr. 11, 2001 (GB) 0109073.7
Jul. 27, 2001 (GB) 0118453.0

(51) Int. Cl. G06F 17/00

(52) U.S. Cl. 707/102

(57) ABSTRACT

When determining the utility score of a contract under negotiation for an automated negotiating engine, it is useful to have a “fuzzy” region of uncertainty of utility score. This provides flexibility in the negotiating rounds. By supplying a confidence level and optionally supplying information about the proposer (for example whether the proposer is friendly or not) it is possible to trim the “fuzzy” range of utility score to provide less flexibility and a more certain outcome.

This invention relates to a method of scoring the utility of a proposed contract and to utility scoring apparatus for determining a utility score.

In automated negotiating apparatus, it is necessary to record and query a negotiating party's preferences concerning acceptable or unacceptable aspects of a contract.

The usual mechanism for deciding whether a contract is acceptable or not, is to record the preferences of a party in a utility surface or preference map which, when details of a proposed contract are put on to the preference map or utility surface, returns a utility score for that contract.

Once the utility score has been generated, the negotiating strategy being used in the negotiation may decide which (if any) proposals are acceptable and/or produce counter-proposals.

In accordance with a first aspect of the invention there is provided a method of scoring the utility of a proposed contract comprising establishing a preference map embodying the preferences of a negotiating party across a predetermined set of negotiable variables, receiving a proposal in the form of a plurality of instantiated values of the negotiable variables, establishing a predetermined confidence value representative of a desired confidence level in a returned utility score, extracting a probabilistic range of utility scores from the preference map which corresponds to a range of utility scores for the received proposal, processing the probabilistic range with the predetermined confidence value to remove the portion of the said range having a probability lower than the desired confidence level, and returning the proposal together with the processed probabilistic range of utility scores for that proposal.

In a second aspect there is provided utility scoring apparatus for determining a utility score comprising a preference database arranged to hold a preference map embodying the preferences of a negotiating party across a predetermined set of negotiable variables, a proposal input arranged to receive a proposal in the form of a plurality of instantiated values of the negotiable variables, a proposal processor arranged to establish a predetermined confidence value representative of a desired confidence level in a returned utility score, to communicate with the preference database to extract a probabilistic range of utility scores from the preference map which corresponds to a range of utility scores for the received proposal, and to process the probabilistic range of utility scores with the predetermined confidence value to remove the portion of the said range having a probability lower than the desired confidence level, and a utility score output arranged to return the received proposal together with the processed probabilistic range of utility scores for that proposal.

Embodiments of the invention will now be described by way of example with reference to the drawings in which:-

FIG. 1 is a plot representing a two-dimensional “fuzzy” utility function;

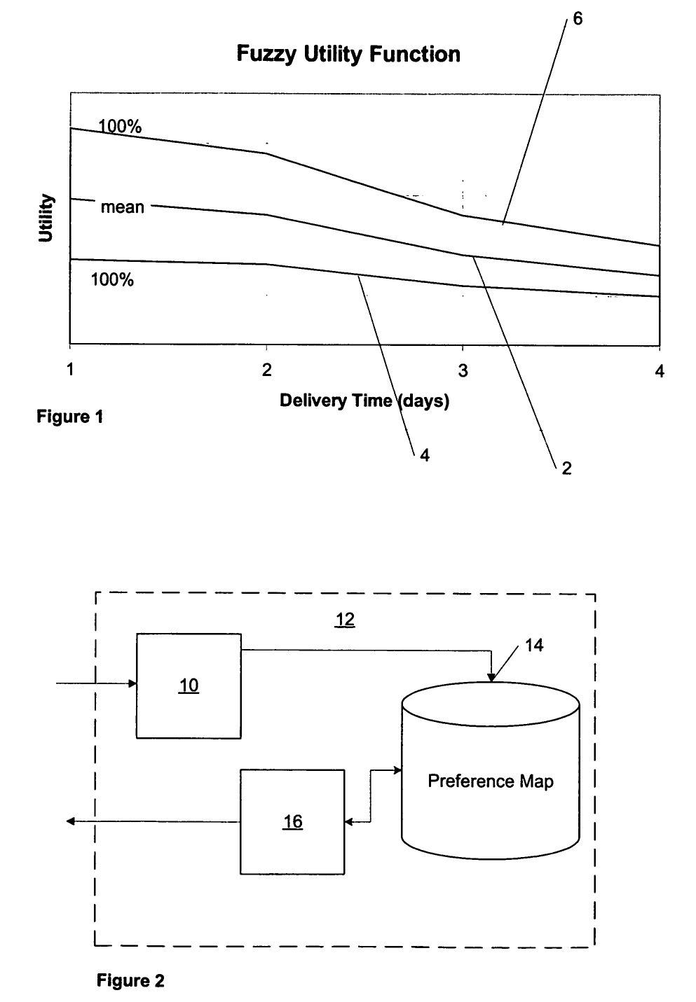

FIG. 2 is a schematic block diagram of utility scoring apparatus in accordance with the invention; and

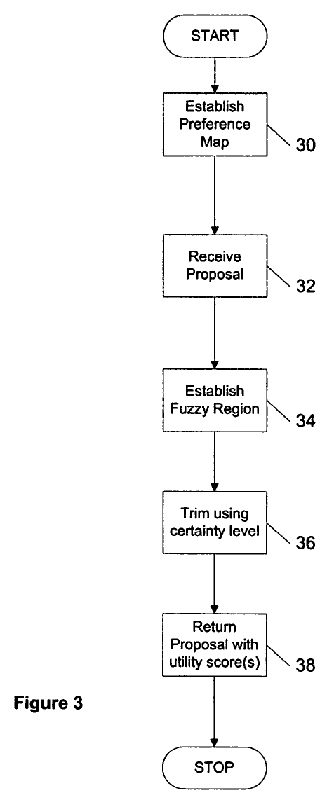

FIG. 3 is a flow chart showing the utility scoring process of the present invention.

With reference to FIG. 1, the creation of a “fuzzy” utility function or preference map is described in detail in the appplicant's copending British Patent Application of even date entitled “Mapping Apparatus and Methods”, the contents of which are incorporated by reference herein. Briefly, such a utility function has a probabilistic range of “utilities” for any given certainty equivalent. Thus, in the figure, a line 2 shows the average (for example, mean) utility function and a spread of probabilistic values from 0 to 100% are shown by lines 4 and 6. Thus, for any given certainty equivalent (for example, delivery time) a probabilistic range of utility scores may be returned.

Thus for example, considering FIG. 1, at a delivery time of two days, the range of utilities having 100% certainty is 0.85 to 1.9. A narrower range of utilities (forming a narrower band around the mean 2) would have a lower probability since we can be less “certain” that the utility will lie in that narrower range.

The apparatus and methods described below makes use of a utility function of the type described above. It will be appreciated that although FIG. 1 shows a two-dimensional function defining delivery time against utility, the certainty equivalent may be a different parameter and also the function may have several dimensions and thus may, for example, encompass a user's preferences concerning quality and particular characteristics of the product such as colour and weight in addition to delivery time.

A practical implementation using this type of utility function is now described in detail with reference to FIG. 2.

An automated negotiating system requests preference information by passing a proposed contract to a proposal input 10 of utility scoring apparatus 12.

The proposal offered to the proposal input 10 takes the form of instantiated values of contract terms being negotiated.

The utility scoring apparatus 12 includes a “fuzzy” or “probabilistic” preference map of the type described above in connection with FIG. 1 which embodies the negotiating party's preferences over the parameters which are being negotiated.

The scoring apparatus 12 includes a processor 16 which is arranged to take the proposal from the proposal input 10 and to determine the range of utility scores for this proposal with reference to the preference map 14.

At this point, there are several options concerning what information is returned to the negotiating system. In its simplest form, the upper and lower bounds of the range may be returned with the proposal. Thus typically in the scenario given in FIG. 1, the upper bound will be an optimistic estimate of utility and the lower bound will be a pessimistic estimate. If desired, additional discrete points within the “fuzzy” region or probabilistic range may also be returned by the processor 16.

Assuming that the negotiating system has been designed with understanding that the utility scores returned from the scoring apparatus 12 represent a range or certainties, then the negotiating system may make sensible choices about which utility score to use and therefore which contracts to accept. For example, if the incoming proposal into the proposal input 10 has been proposed by itself or a potential trading partner (i.e. they are friendly proposals) then the pessimistic estimate of utility will be used. On the other hand, if the incoming proposal is a competitors proposal then the optimistic estimate is likely to be used.

Thus, if it is desired to be cautious then the value of a proposal which is to be made and the value of proposals made by potential trading partners which it may be wished to accept, should be assessed using the pessimistic estimate of the utility. On the other hand, the value of proposals made by competitors (and which it will typically be desired to “beat” to make a trade with a potential trading partner) would be assessed using the optimistic estimate.

As a further alternative, if it is desired to take a “risky attitude” in order to attempt to strike a better deal, the optimistic and pessimistic utility estimates may be used in the reverse way to that described above.

As a further enhancement, it may be desired to adopt a position in between the extremes described above by choosing a position (for example 60%) in the range between the pessimistic and optimistic estimates for assessing proposals which it is wished to make and proposals of potential trade partners and choosing a position 60% of the way between the optimistic and pessimistic estimates for assessing proposals of competitors.

As a further alternative, the incoming proposal may include information about the source of the contract, for example, whether it is from a potential trade partner or a competitor. In this case, the scoring apparatus 12 may select the most appropriate portion of the “fuzzy” region returned by the preference map 14 and return a single utility score to the negotiating system. This allows a “legacy” negotiating system to be used with the utility scoring apparatus of the present invention.

As a further enhancement, the proposal received at the proposal input 10 may specify a confidence level which may be used to “trim” the “fuzzy” region returned from the preference map 14. Thus, if is desired to have absolute certainty that the range of utilities returned by the function is correct then the 100% levels shown in FIG. 1 are chosen and the whole range of utility scores is returned. If it is possible to accept only 50% certainty then the narrower 50% region closer to the mean than the two 100% regions marked in FIG. 1 may be returned. Hence, the lower the acceptable confidence level, the “harder” the resulting utility function will be (it will have a narrower range of values). In the absence of an explicit confidence level, the scoring apparatus may select a default confidence level.

Thus, the use of confidence levels may allow a user to reduce its flexibility in negotiating a particular contract by “hardening” its utility function in this way. The functional effect of this is that, for example, with a high confidence level input with the proposal, the negotiating system will be inflexible about the parameters of the contract such as price and delivery time. With a reduced confidence level input with the proposal, the flexibility would be increased and it is likely that wider ranges of prices and delivery times etc. will be indicated as acceptable by the negotiating system.

As a yet further enhancement, the proposal processor 16 may analyse the results as they are received from the preference map 14 and detect areas of the preference map which need greater refinement. For example, if it is determined that an optimistic estimate of a trading partner's proposal is better than a pessimistic estimate of the user's own proposal, there is a potential overlap of desirable outcomes for the negotiation and thus the user may be queried to determine which proposal is preferable of the two proposals. Thus, either the scoring apparatus 12 may indicate that the result may be poor because there is a potential inconsistency, or it may initiate questioning of the user to further refine the preference map.

With reference now to FIG. 3, the steps involved in querying the preference map and returning a utility score are set out.

Firstly, a preference map is established in accordance with the principles set out in connection with the description of FIG. 1. The acquisition of data from a user to create this preference map is described in more detail in co-pending application No., the disclosure of which is incorporated herein by reference.

In step 32 a proposal is received in the form of a plurality of instantiated values of the parameters or variables which are being negotiated upon.

The “fuzzy” region of utility which corresponds to the received proposal is then extracted from the preference map in step 34.

The “fuzzy” region is then trimmed (step 36) by applying a confidence level either supplied with the incoming proposal or a default confidence level.

The proposal is then returned complete with one or more utility scores for the that proposal (step 38).

1. A method of scoring the utility of a proposed contract comprising:
(a) establishing a preference map embodying the preferences of a negotiating party across a predetermined set of negotiable variables,
(b) receiving a proposal in the form of a plurality of instantiated values of the negotiable variables,
(c) establishing a predetermined confidence value representative of a desired confidence level in a returned utility score,
(d) extracting a probabilistic range of utility scores from the preference map which corresponds to a range of utility scores for the received proposal,
(e) processing the probabilistic range with the predetermined confidence value to remove the portion of the said range having a probability higher than the desired confidence level, and
(f) returning the proposal together with the processed probabilistic range of utility scores for that proposal.

2. A method according to claim 1, wherein the predetermined confidence value is a default value which is the same for all received proposals.

3. A method according to claim 1, wherein the received proposal includes a confidence value which is used to process the probabilistic range.

4. A method according to claim 3, wherein the received proposal includes a source indicator which provides an indication of the source of the proposal.

5. A method according to claim 4, wherein the predetermined confidence value is automatically selected depending on the indicated source of the proposal.

6. A method according to claim 4, wherein the returned utility score is processed with the source indicator to determine which portion or portions of the processed probabilistic range of utility scores is returned.

7. A method according to claim 1, wherein the received proposal includes a source indicator which provides an indication of the source of the proposal.

8. A method according to claim 7, wherein the predetermined confidence value is automatically selected depending on the indicated source of the proposal.

9. A method according to claim 7, wherein the returned utility score is processed with the source indicator to determine which portion or portions of the processed probabilistic range of utility scores is returned.

10. A method according to claim 1, wherein the utility scores are returned as a set of discrete utility scores within the processed probabilistic range such as the upper and lower bound of the processed range.

11. A method according to claim 10, wherein the received proposal includes a source indicator which provides an indication of the source of the proposal.

12. A method according to claim 11, wherein the predetermined confidence value is automatically selected depending on the indicated source of the proposal.

13. A method according to claim 11, wherein the returned utility score is processed with the source indicator to determine which portion or portions of the processed probabilistic range of utility scores is returned.

14. A method according to claim 10, wherein the predetermined confidence value is a default value which is the same for all received proposals.

15. A method according to claim 14, wherein the received proposal includes a source indicator which provides an indication of the source of the proposal.

16. A method according to claim 15, wherein the predetermined confidence value is automatically selected depending on the indicated source of the proposal.

17. A method according to claim 15, wherein the returned utility score is processed with the source indicator to determine which portion or portions of the processed probabilistic range of utility scores is returned.

18. A method according to claim 10, wherein the received proposal includes a confidence value which is used to process the probabilistic range.

19. A method according to claim 18, wherein the received proposal includes a source indicator which provides an indication of the source of the proposal.

20. A method according to claim 19, wherein the predetermined confidence value is automatically selected depending on the indicated source of the proposal.

21. A method according to claim 19, wherein the returned utility score is processed with the source indicator to determine which portion or portions of the processed probabilistic range of utility scores is returned.

22. Utility Scoring apparatus for determining a utility score comprising:
(a) a preference database arranged to hold a preference map embodying the preferences of a negotiating party across a predetermined set of negotiable variables,
(b) a proposal input arranged to receive a proposal in the form of a plurality of instantiated values of the negotiable variables,
(c) a proposal processor arranged to establish a predetermined confidence value representative of a desired confidence level in a returned utility score, to communicate with the preference database to extract a probabilistic range of utility scores from the preference map which corresponds to a range of utility scores for the received proposal, and to process the probabilistic range of utility scores with the predetermined confidence value to remove the portion of the said range having a probability higher than the desired confidence level, and
(d) a utility score output arranged to return the received proposal together with the processed probabilistic range of utility scores for that proposal.

23. Apparatus according to claim 22, wherein the proposal processor is further arranged to establish a predetermined confidence value which is a default value which is the same for all received proposals.

24. Apparatus according to claim 22, wherein the proposal input is arranged to receive a proposal which includes a confidence value which is used to process the probabilistic range.

25. Apparatus according to claim 22, wherein the proposal input is further arranged to receive a proposal which includes a source indicator which provides an indication of the source of the proposal.

26. Apparatus according to claim 22, wherein the utility score output is arranged to return the utility scores as a set of discrete utility scores within the processed probabilistic range such as the upper and lower bound of the processed range.

27. Apparatus according to claim 26, wherein the proposal processor is further arranged to establish a predetermined confidence value which is a default value which is the same for all received proposals.

28. Apparatus according to claim 26, wherein the proposal input is arranged to receive a proposal which includes a confidence value which is used to process the probabilistic range.

29. Apparatus according to claim 26, wherein the proposal input is further arranged to receive a proposal which includes a source indicator which provides an indication of the source of the proposal.

30. Apparatus according to claim 23, wherein the proposal input is further arranged to receive a proposal which includes a source indicator which provides an indication of the source of the proposal.

31. Apparatus according to claim 30, wherein the proposal processor is further arranged to select the predetermined confidence value automatically depending on the indicated source of the proposal.

32. Apparatus according to claim 30, wherein the proposal processor is arranged to process the probabilistic range of utility scores with the source indicator to determine which portion or portions of the said processed probabilistic range of utility scores is returned.
